(19) United States
(12) Patent Application Publication
(10) Pub. No.: US 2018/0114640 A1
(43) Pub. Date: Apr. 26, 2018

(54) CAPACITOR

(71) Applicant: Murata Manufacturing Co., Ltd., Nagaokakyo-shi (JP)

(72) Inventors: NORIYUKI INOUE, Nagaokakyo-shi (JP); Kazuo Hattori, Nagaokakyo-shi (JP); Hiromasa Saeki, Nagaokakyo-shi (JP)

(21) Appl. No.: 15/849,815

(22) Filed: Dec. 21, 2017

Related U.S. Application Data
(63) Continuation of application No. PCT/JP2016/072194, filed on Jul. 28, 2016.

(30) Foreign Application Priority Data
Aug. 7, 2015 (JP) 2015-157354

(51) Int. Cl. H01G 4/08; H01G 4/248; H01G 4/33

(52) U.S. Cl. CPC H01G 4/08; H01G 4/33; H01G 4/248

(57) ABSTRACT

A capacitor having an element main body including a metal high specific surface area substrate which has fine pores formed therein and has a large specific surface area; a dielectric layer in a prescribed region on the surface of the high specific surface area substrate including the inner surfaces of the pores; and a conductive part on the dielectric layer. A first terminal electrode is electrically connected to the high specific surface area substrate. A second terminal electrode is electrically connected to the conductive part. The element main body includes a first region that contributes to the acquisition of the capacitance and second regions having a smaller void ratio than the first region. The second regions have a void ratio of 25% or less.

### CROSS REFERENCE TO RELATED APPLICATIONS

The present application is a continuation of International application No. PCT/JP2016/072194, filed Jul. 28, 2016, which claims priority to Japanese Patent Application No. 2015-157354, filed Aug. 7, 2015, the entire contents of each of which are incorporated herein by reference.

### FIELD OF THE INVENTION

The present invention relates to a capacitor.

### BACKGROUND OF THE INVENTION

Nowadays, many and various capacitors are installed in electronic devices such as personal computers and handheld terminals. Among this type of capacitors, a solid electrolytic capacitor can make a dielectric layer thinner since an oxide film formed by anodizing is used as a dielectric layer, and therefore the solid electrolytic capacitor is widely used as a capacitor which can be miniaturized and whose capacity can be increased.

For example, Patent Document 1 proposes a solid electrolytic capacitor including an anode containing a valve action metal or an alloy thereof, a dielectric layer disposed on the surface of the anode, a cathode disposed on the surface of the dielectric layer, and an outer body resin covering the anode, the dielectric layer and the cathode, wherein a glass transition temperature of the outer body resin ranges from 0.50 times to 0.90 times as high as a maximum glass transition temperature.

In Patent Document 1, the anode is formed of a porous sintered body predominantly composed of a valve metal such as Nb, the porous sintered body is subjected to anodizing to form a dielectric layer made of an oxide film, an electrolyte layer formed of a conductive polymer such as polypyrrole is disposed on the dielectric layer to form a cathode of the electrolyte layer. Then, Patent Document 1 proposes obtaining a solid electrolytic capacitor in which a leakage current is small and a reduction of the capacitance in high-temperature storage is suppressed by setting the glass transition temperature of the outer body resin to the above-mentioned range.

Patent Document 1: Japanese Patent Application Laid-Open No. 2009-54906 (claim 1, paragraphs [0020], [0029] to [0038])

### SUMMARY OF THE INVENTION

However, in the solid electrolytic capacitor described in Patent Document 1, since the anode is formed of a porous sintered body predominantly composed of a valve metal, a void ratio is large and mechanical strength is low although a high capacity of capacitance can be acquired, and therefore a defective product tends to be produced in a production process, and there is a possibility of resulting in a reduction of a yield. Further, as described in Patent Document 1, in order to ensure the mechanical strength in mounting on a board, a capacitor needs to be armored with a resin and this can cause high production costs.

The present invention has been made in view of such a situation, and it is an object of the present invention to provide a new type of capacitor which can be made smaller and higher capacity, is excellent in mechanical strength without impairing insulating properties and has high reliability.

The present inventors used a metal high specific surface area substrate which has fine pores formed therein and has a large specific surface area, formed a dielectric layer and a conductive part on and above the high specific surface area substrate to prepare a capacitor structure, and made earnest investigations of the capacitor, and consequently, they found that a capacitor which is small and high capacity can be attained.

However, this capacitor also has difficulty in obtaining sufficient mechanical strength as with the solid electrolytic capacitor since many fine pores are formed in the high specific surface area substrate.

Thus, the present inventors further made earnest investigations, and consequently they obtained findings that by varying a void ratio of the high specific surface area substrate constituting the element main body, and providing a region having a small void ratio, specifically, a region having a void ratio of 25% or less in the element main body, mechanical strength is markedly improved and can also suppress the occurrence rate of a defective product in a production process, and thereby a product yield is improved to achieve high reliability.

That is, a capacitor according to the present invention is a capacitor in which at least two terminal electrodes electrically insulated from each other are formed on the surface of an element main body, wherein the element main body has a high specific surface area substrate made of an electrical conductive material which has fine pores formed therein and has a large specific surface area; a dielectric layer is formed in a prescribed region of the surface of the high specific surface area substrate including the inner surfaces of the pores; and a conductive part formed on the dielectric layer, one terminal electrode of the two terminal electrodes is electrically connected to the high specific surface area substrate and the other terminal electrode is electrically connected to the conductive part, the element main body has a plurality of regions including a first region that principally contributes to the acquisition of the capacitance and a second region having a smaller void ratio than the first region in accordance with the void ratio of the high specific surface area substrate, and the second region is formed such that the void ratio is 25% or less.

In the present invention, the second region having a void ratio of 25% or less may exist in the element main body, and various forms can be employed according to uses, performance/quality which are required, or the like concerning a location where such a second region is formed.

That is, in the capacitor of the present invention, preferably, the second regions are provided consecutively at both ends of the first region, respectively.

Further, in the capacitor of the present invention, preferably, the second region is interposed in the first region in parallel to an end surface of the element main body.

Also, in the capacitor of the present invention, it is preferred that the second region has a first and a second sites provided consecutively at both ends of the first region, respectively, and a third site interposed in the first region, and the first site is connected to the second site with the third site interposed therebetween.

Further, in the capacitor of the present invention, it is preferred that the second region has a first and a second sites provided consecutively at both ends of the first region, respectively, and a third site formed along at least one principal surface of the first region, and the first site is connected to the second site with the third site interposed therebetween.

Further, in the capacitor of the present invention, the first region is preferably surrounded with the second region.

Then, in the capacitor of the present invention, the dielectric layer is interposed between the conductive part and the high specific surface area substrate, and the high specific surface area substrate and the other terminal electrode are electrically insulated from each other.

Thereby, a new type of capacitor which has low resistance and good insulating properties and has high reliability can be obtained.

In the capacitor of the present invention, the dielectric layer is preferably formed by being deposited in increments of an atomic layer.

Thereby, a dense dielectric layer can be attained, and it is possible to inhibit a defect from being produced, resulting in a reduction of insulating properties in contrast to the anodizing in a solid electrolytic capacitor, and to obtain a capacitor having high insulating properties.

Further, in the capacitor of the present invention, the conductive part is preferably formed by being filled in the inside of the pores.

Furthermore, in the capacitor of the present invention, the conductive part is also preferably formed along the dielectric layer inside the pores.

In any of the case where the conductive part is formed by being filled in the inside of the pores and the case where the conductive part is formed along the dielectric layer inside the pores, a new type of capacitor which is small and high capacity, and is not in a conventional capacitor can be obtained since a capacitance is acquired by utilizing many pores.

In the capacitor of the present invention, the electrical conductive material is preferably a metal material.

In the capacitor of the present invention, the conductive part is preferably formed of any one of a metal material and a conductive compound, and the conductive compound preferably contains a metal nitride or a metal oxynitride.

When the conductive part is formed of a metal material with low resistance, equivalent series resistance (hereinafter, referred to as “ESR”) can be further reduced, and when the conductive part is formed of a conductive compound such as a metal nitride or a metal oxynitride, a conductive part having good uniformity can be formed up to the inside of the pores.

In the capacitor of the present invention, the element main body preferably has at least side surface parts covered with a protective layer made of an insulating material.

Thereby, it becomes possible to secure mechanical strength even in actual uses.

Also, in the capacitor of the present invention, it is preferred that the element main body has at least side surface parts covered with a protective layer made of an insulating material, and a metal film is interposed between the protective layer and the conductive part.

As described above, by interposing the metal film as required, resistance can be further reduced and ESR can be further reduced.

According to the capacitor of the present invention, it is possible to obtain a capacitor which is small, high capacity, and highly reliable, can suppress the occurrence of deformation or the like in a production process, and has good mechanical strength to improve a product yield without impairing insulating properties, for example, since the element main body has a high specific surface area substrate made of an electrical conductive material which has fine pores formed therein and has a large specific surface area; a dielectric layer which is formed in a prescribed region of the surface of the high specific surface area substrate including the inner surfaces of the pores; and a conductive part formed so as to meet the dielectric layer, one terminal electrode of the two terminal electrodes is electrically connected to the high specific surface area substrate and the other terminal electrode is electrically connected to the conductive part, the element main body has a plurality of regions including a first region that principally contributes to the acquisition of the capacitance and a second region having a smaller void ratio than the first region in accordance with the void ratio of the high specific surface area substrate, and the second region is formed such that the void ratio of the high specific surface area substrate is 25% or less.

### BRIEF EXPLANATION OF THE DRAWINGS

FIG. 1 is a schematic cross-sectional view of an embodiment of a capacitor according to the present invention.

FIG. 2 is a sectional view viewed from the arrow direction of the X-X line of FIG. 1.

FIG. 3 is a greatly enlarged detailed sectional view of an A part of FIG. 1.

FIG. 4 is a greatly enlarged detailed sectional view of a B part of FIG. 1.

FIG. 5 is a greatly enlarged detailed sectional view of a C part of FIG. 1.

FIGS. 6(a) to 6(c) are manufacturing process views schematically showing a method for manufacturing a capacitor according to the present invention.

FIGS. 7(di) to 7(d2) are manufacturing process views schematically showing a method for manufacturing a capacitor according to the present invention.

FIG. 8(e) is a manufacturing process view schematically showing a method for manufacturing a capacitor according to the present invention.

FIGS. 9(f₁) to 9(f₂) are manufacturing process views schematically showing a method for manufacturing a capacitor according to the present invention.

FIGS. 10(g) to 10(h) are manufacturing process views schematically showing a method for manufacturing a capacitor according to the present invention.

FIGS. 11(i) to 11(k) are manufacturing process views schematically showing a method for manufacturing a capacitor according to the present invention.

FIG. 12 is a schematic cross-sectional view of a second embodiment of a capacitor according to the present invention.

FIG. 13 is a schematic cross-sectional view of a third embodiment of a capacitor according to the present invention.

FIG. 14 is a schematic cross-sectional view of a fourth embodiment of a capacitor according to the present invention.

FIG. 15 is a schematic cross-sectional view of a fifth embodiment of a capacitor according to the present invention.

FIG. 16 is an enlarged sectional view of a main part of a sixth embodiment of a capacitor according to the present invention.

FIG. 17 is a schematic cross-sectional view of a seventh embodiment of a capacitor according to the present invention.

FIG. 18 is a schematic cross-sectional view of an eighth embodiment of a capacitor according to the present invention.

FIG. 19 is a schematic cross-sectional view of a ninth embodiment of a capacitor according to the present invention.

FIG. 20 is a schematic cross-sectional view of a tenth embodiment of a capacitor according to the present invention.

### DETAILED DESCRIPTION OF THE INVENTION

Next, an embodiment of the present invention will be described in detail.

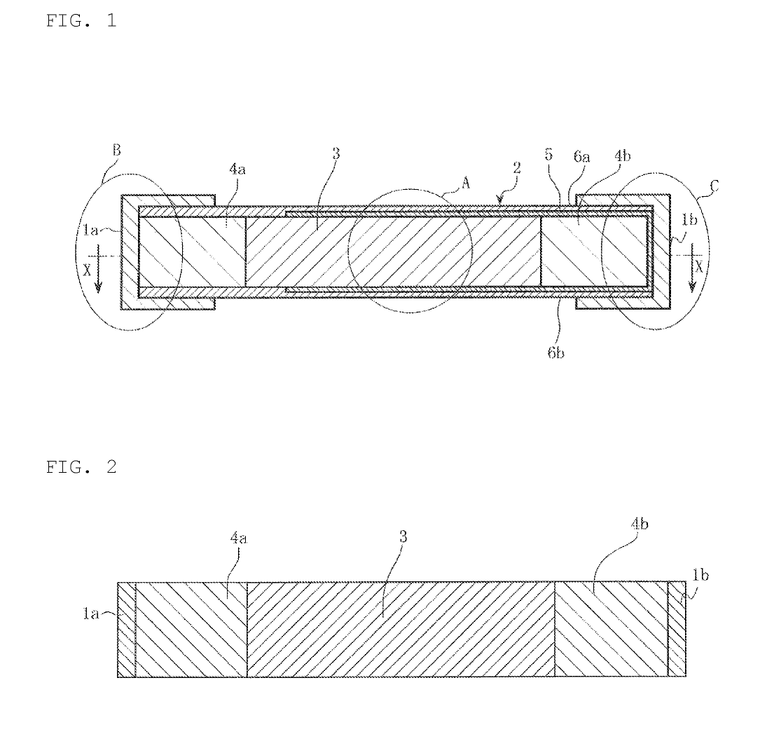

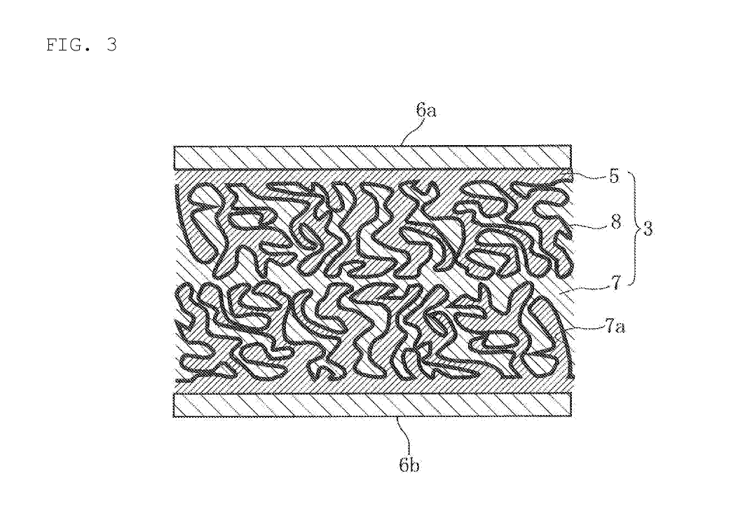

FIG. 1 is a schematic cross-sectional view of an embodiment (first embodiment) of a capacitor according to the present invention, and FIG. 2 is a sectional view viewed from the arrow direction of the X-X line of FIG. 1.

In the capacitor, two terminal electrodes (a first terminal electrode 1a and a second terminal electrode 1b) electrically insulated from each other are formed at both ends of an element main body 2.

The element main body 2 is comparted into a first region 3 that principally contributes to the acquisition of the capacitance and second regions 4a, 4b formed at both ends of the first region 3. That is, the second regions 4a and 4b are provided consecutively at both ends of the first region 3, respectively. A conductive part 5 is formed on the first region 3 and the second region 4b, and further, protective layers 6a and 6b made of an insulating material are formed on both principal surfaces of the element main body 2.

FIG. 3 is an enlarged sectional view showing a detail of an A part of FIG. 1.

That is, the first region 3 has a high specific surface area substrate 7 made of an electrical conductive material which has fine pores 7a formed therein and has a large specific surface area, a dielectric layer 8 which is formed on the surface of the high specific surface area substrate 7, and the above-mentioned conductive part 5.

The dielectric layer 8 is formed in a prescribed region of the surface including the inner surfaces of the pores 7a, and deposited in increments of an atomic layer. Thereby, the dielectric layer 8 is formed as a dense film, and therefore defects are few and insulating properties are high in contrast to the case of a solid electrolytic capacitor in which the dielectric layer is formed through anodizing. Further, since a polarity is not imparted to a capacitor, a capacitor having good usability can be attained.

The conductive part 5 is formed on the dielectric layer 8 so as to cover and fill the pores 7a with the material that forms the conductive part 5. Further, the conductive part 5 is formed along both of upper and lower principal surfaces of the high specific surface area substrate 7.

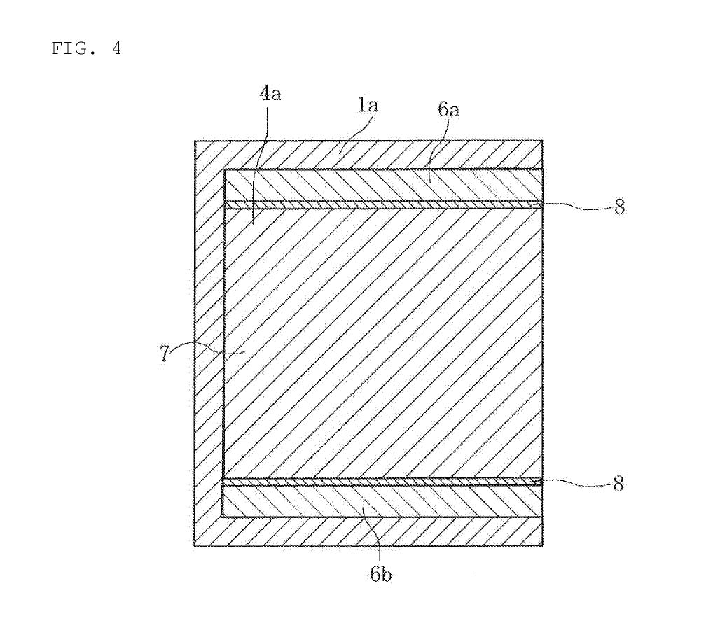

FIG. 4 is an enlarged sectional view showing a detail of a B part of FIG. 1.

In the second region 4a, the dielectric layer 8 is formed on the surface of the high specific surface area substrate 7 excluding an end surface of the substrate 7, the high specific surface area substrate 7 is exposed to the surface at the end surface, and the first terminal electrode la and the high specific surface area substrate 7 are electrically connected to each other.

In addition, in FIG. 4, as described above, the dielectric layer 8 is formed on the surface of the high specific surface area substrate 7 excluding an end surface of the substrate 7, that is, a whole area of side surface of the substrate 7, in the second region 4a, but the dielectric layer 8 does not always have to be formed on the whole area of the side surface of the second region 4a, and a part of the side surface of the high specific surface area substrate 7 does not have to be covered with the dielectric layer 8.

FIG. 5 is an enlarged sectional view showing a detail of a C part of FIG. 1.

In the second region 4b, the dielectric layer 8 is formed on the surface of the high specific surface area substrate 7, and the conductive part 5 is formed on the surface of the dielectric layer 8. Then, the conductive part 5 is electrically connected to the second terminal electrode 1b, and the second terminal electrode 1b and the high specific surface area substrate 7 are electrically insulated from each other with the dielectric layer 8 interposed therebetween.

As described above, the element main body 2 has the first region 3 formed integrally with the second regions 4a and 4b, the above-mentioned high specific surface area substrate 7 as a substrate, the dielectric layer 8 and the conductive part 5. Then, the first region 3 is a region that principally contributes to the acquisition of the capacitance, and therefore in the first region 3, the high specific surface area substrate 7 is formed so as to increase the void ratio. That is, the void ratio of the high specific surface area substrate 7 in the first region 3 is not particularly limited; however, the first region 3 is formed so that the void ratio is preferably 30 to 80%, and more preferably 35 to 65% in consideration of mechanical strength since the first region 3 is, as described above, a region that principally contributes to the acquisition of the capacitance.

On the other hand, the second regions 4a and 4b are each a region that contributes to the securement of the mechanical strength, and therefore the second regions 4a and 4b are formed so as to have a smaller void ratio than the first region 3. That is, since the second regions 4a and 4b are each a region that contributes to the securement of the mechanical strength, these regions are formed so to have a void ratio of 25% or less, preferably 10% or less, and may be 0% at which the void does not exist.

In addition, a method of manufacturing the high specific surface area substrate 7 is not particularly limited, and for example, the high specific surface area substrate 7 can be manufactured by an etching method, a sintering method, a dealloying method or the like as described later, and a metallic etching foil, a sintered body, a porous metal body or the like respectively manufactured by these methods can be used as the high specific surface area substrate 7.

The second regions 4a and 4b can be formed by subjecting the high specific surface area substrate 7 to press working or laser irradiation, for example, to cause the destruction of the pores 7a. A regional ratio between the first region 3 and the second regions 4a and 4b in the high specific surface area substrate 7 is set according to a capacitance to be acquired. For example, the regional ratio of the first region 3 is increased in the case of preparing a capacitor having a high capacity, and on the other hand, the regional ratio of the second regions 4a and 4b is increased in the case of securing the mechanical strength but reducing the capacitance.

A thickness of the high specific surface area substrate 7 is not particularly limited; however, the thickness is preferably 10 to 1000 μm, and more preferably 30 to 300 μm from the viewpoint of achieving desired miniaturization while securing the mechanical strength.

In addition, in the present embodiment, by improving the mechanical strength, a ratio of a length L to a height H of the element main body 2 can be set to 3 or more, preferably 4 or more, and therefore a capacitor which is low in height and is small and high capacity can be obtained.

A material of such a high specific surface area substrate 7 is not particularly limited as long as the material has a conductive property, and for example, metal materials such as Al, Ta, Ni, Cu, Ti, Nb and Fe, or alloy materials such as stainless steel and duralumin can be used.

However, the high specific surface area substrate 7 is preferably formed of a highly conductive material, particularly a metal material having specific resistance of 10 μΩ·cm or less, from the viewpoint of more effectively reducing the ESR, and a semiconductor material such as Si is not preferred.

A material for forming the dielectric layer 8 is not particularly limited as long as the material has insulating properties, and it is possible to use, for example, AlOₓ such as Al₂O₃; SiOₓ such as SiO₂; metal oxides such as AlTiOₓ, SiTiOₓ, HfOₓ, TaOₓ, ZrOₓ, HfSiOₓ, ZrSiOₓ, TiZrOₓ, TiZrWOₓ, TiOₓ, SrTiOₓ, PbTiOₓ, BaTiOₓ, BaSrTiOₓ, BaCaTiOₓ and SiAlOₓ; metal nitrides such as AlNₓ, SiNₓ and AlScNx; and metal oxynitrides such as AlOₓN_{y}, SiOₓN_{y}, HfSiOₓN_{y} and SiCₓO_{y}N_{z}. Further, the dielectric layer 8 does not need to have crystallinity from the viewpoint of forming a dense film, and an amorphous film is preferably used.

A thickness of the dielectric layer 8 is not particularly limited; however, the thickness is preferably 3 to 100 nm, and more preferably 10 to 50 nm from the viewpoint of enhancing insulating properties to inhibit a leakage current and securing a large capacitance.

The variation of the film thickness of the dielectric layer 8 is not particularly limited; however, the film thickness preferably has uniformity from the viewpoint of acquiring a stable and desired capacitance. In the present embodiment, the variation of the film thickness can be 10% or less on an absolute value basis with reference to an average film thickness by using an atomic layer deposition method described later.

A material for forming the conductive part 5 is not particularly limited as long as it has a conductive property, and Ni, Cu, Al, W, Ti, Ag, Au, Pt, Zn, Sn, Pb, Fe, Cr, Mo, Ru, Pd and Ta, and alloys thereof (for example, CuNi, AuNi and AuSn); metal nitrides such as TiN, TiAlN and TaN; metal oxynitrides such as TiON and TiAlON; and conductive polymers such as PEDOT/PSS (poly(3,4-ethylenedioxythiophene)/polystyrene sulfonic acid), polyaniline and polypyrrole, for example, can be used, and metal nitrides and metal oxynitrides are preferred in consideration of a filling property in the pores 7a or film-forming properties. In addition, when such a metal nitride or metal oxide nitride, or a conductive polymer is used, it is preferred to form a metal film such as a Cu film or a Ni film on the surface of the conductive part 5 by a plating method or the like in order to further reduce electric resistance.

A thickness of the conductive part 5 is also not particularly limited; however, it is preferably 3 nm or more, and more preferably 10 nm or more for obtaining a conductive part 5 having lower resistance.

A material for forming the protective layers 6a and 6b is also not particularly limited as long as the material has insulating properties, and the same material as in the dielectric layer 8, for example, SiNₓ, SiOₓ, AlTiOₓ and AlOₓ, can be used; however, SiOₓ is preferably used, and resin materials such as an epoxy resin and a polyimide resin, and a glass material, for example, can also be used.

A thickness of the protective layers 6a and 6b is not particularly limited as long as the thickness can ensure moisture resistance and insulating properties, for example, and the protective layers can be formed, for example, in a thickness of about 0.3 μm to 50 μm, preferably about 1 μm to 20 μm.

Forming materials and thicknesses of the first and the second terminal electrodes 1a and 1b are also not particularly limited as long as they provide a desired conductive property, and for example, metal materials such as Cu, Ni, Sn, Au, Ag, and Pb, or alloys thereof, for example, can be used. The thickness to be formed is 0.5 to 50 μm, and preferably 1 μm to 20 μm.

As described above, in the present embodiment, it is possible to obtain a capacitor which is small, has high capacity, is highly reliable, can suppress the occurrence of deformation or the like in a production process, and has good mechanical strength to improve a product yield without impairing insulating properties.

In the present capacitor, since the high specific surface area substrate 7 has the second regions 4a and 4b having as small a void ratio as 25% or less and high mechanical strength, it is possible to improve the durability against stress, particularly, flexure stress, added in mounting on a substrate such as a glass epoxy substrate, a ceramic substrate or a resin substrate.

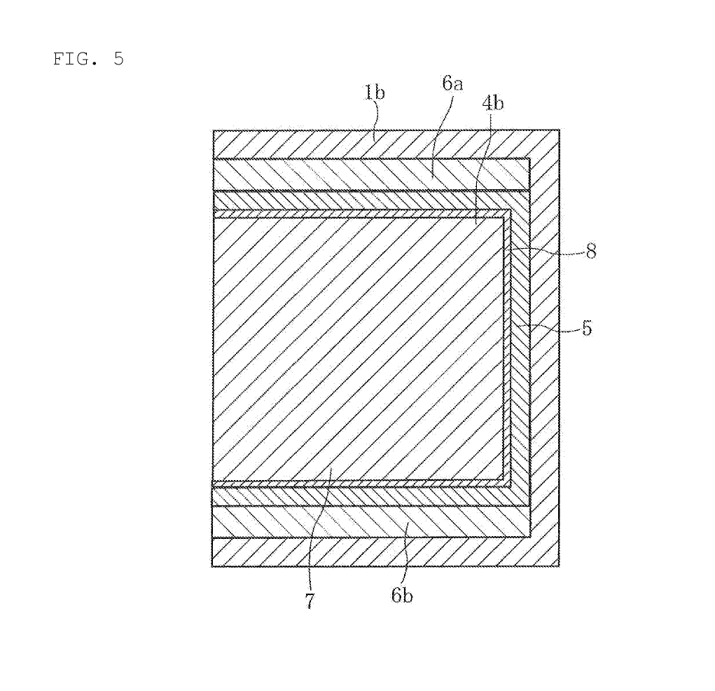

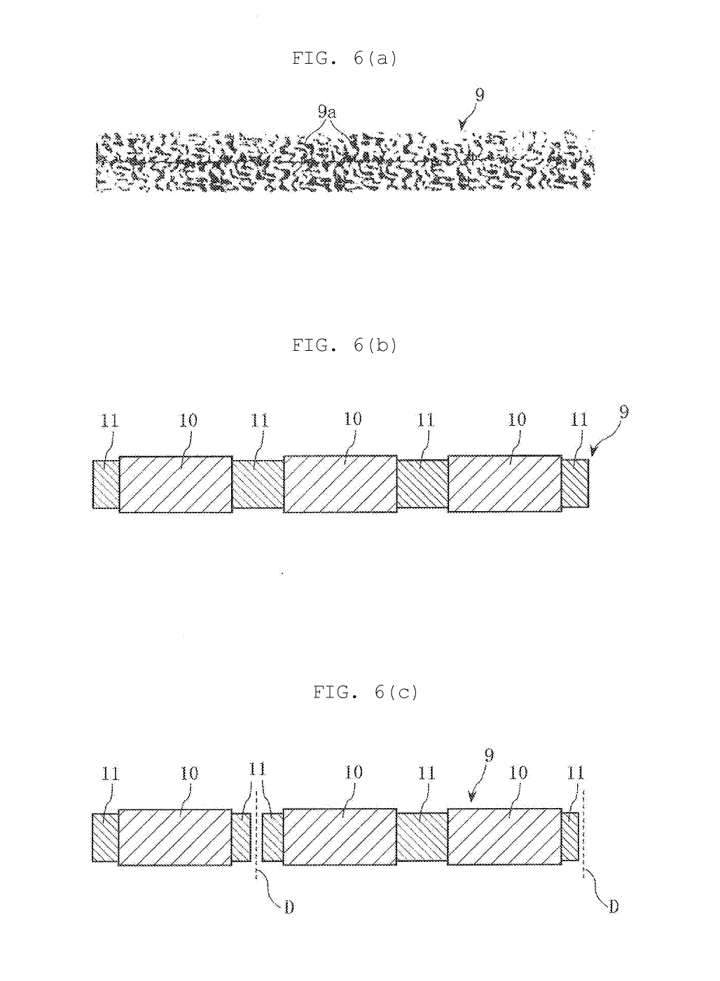

Next, a method for manufacturing the above-mentioned capacitor will be described in detail based on FIG. 6(a) to FIG. 11(k).

First, as shown in FIG. 6(a), is prepared an aggregate substrate 9 made of an electrical conductive material which has fine pores 9a formed therein and has a large specific surface area.

As the aggregate substrate 9, as described above, the metallic etching foil, the metal sintered body, the porous metal body or the like can be used.

The metallic etching foil can be produced by passing a predetermined current in an optional direction through a metal foil such as an Al foil and etching the metal foil. The metal sintered body can be produced by forming a metal powder such as Ta and Ni in the form of a sheet, heating the resulting metal sheet at a temperature lower than a melting point of the metal, and firing the sheet. The porous metal body can be produced by using the dealloying method. That is, only a less noble metal is dissolved in an electrolytic solution such as an acid and removed from a binary alloy of an electrochemically noble metal and an electrochemically less noble metal. The nobler metal remaining undissolved in dissolving/removing the less noble metal forms open pores of the order of nanometer, and thereby a porous metal body can be produced. In this way, a produced aggregate substrate 9 is prepared.

Next, as shown in FIG. 6(b), the aggregate substrate 9 is subjected to a comparting treatment to compart the aggregate substrate 9 into a first region site 10 serving as the above-mentioned first region 3 and a second region site 11 serving as a second region 4a or 4b.

A method of the comparting treatment is not particularly limited, and the above-mentioned sites can be formed by causing the destruction of the pores 9a of the aggregate substrate 9 using press working, laser irradiation or the like.

For example, when the comparting treatment is performed using press working, a die having a prescribed width dimension is used, a pressure is applied to the aggregate substrate 9 from both of an upper side and a lower side, or one principal surface of the aggregate substrate 9 is fixed to a pedestal or the like, and a pressure is applied to the other principal surface using a die or the like, and thereby, the second region site 11 can be formed. In this case, by adjusting the width dimension of the die or the like, the regional ratio between the first region site 10 and the second region site 11 can be adjusted, and the capacitance of a capacitor can be adjusted as described above.

When the comparting treatment is performed using laser irradiation, a predetermined location of the aggregate substrate 9 is irradiated with a YVO₄ laser, a CO₂ laser, a YAG laser, an excimer laser, a fiber laser, or a full solid state pulsed laser such as a femtosecond laser, a picosecond laser, or a nanosecond laser to cause the destruction of the pores 9a, and thereby the second region site 11 having the void ratio of 25% or less can be formed. In addition, when the second region site 11 is formed by such laser irradiation, the above-mentioned full solid state pulsed laser is preferably used in order to control a shape or a void ratio of the second region site 11 with higher precision.

The comparting treatment can be performed by a method other than the press working or the laser irradiation. For example, the pores 9a of the aggregate substrate 9 may be filled by an appropriate method to cause the destruction of the pores 9a, and thereby, the second region site 11 is obtained. Further, when the aggregate substrate 9 is formed of the metallic etching foil, a location on which the second region site 11 is to be formed is masked with a masking material and etched, the etched location is designated as a first region site 10 and a non-etched location is designated as a second region site 11, and thereby, the comparting treatment can be performed.

Next, as shown in FIG. 6(c), the aggregate substrate 9 is cut along a broken line D. That is, the second region site 11 is cut at its central part or its roughly central part so as to form a set of two first region sites 10 between which the second region site 11 is sandwiched.

Here, a method of cutting the aggregate substrate 9 is not particularly limited, and the aggregate substrate 9 can be easily cut, for example, by cutting by laser irradiation, die cutting, or use of a cutting tool such as a dicer, a cemented carbide blade, a slitter and a pinnacle blade.

In addition, the occurrence of burrs or shear drop can be suppressed by thus cutting the aggregate substrate 9 at the second region site 11 with a small void ratio. That is, when the aggregate substrate 9 which has fine pores 9a formed therein and has a large specific surface area is cut, there is a possibility that burrs are generated or shear drop occurs resulting from extension/deformation, for example, in a cutting direction of a cutting surface. However, the occurrence of burrs or shear drop can be suppressed by cutting the aggregate substrate 9 at the second region site 11 with a small void ratio like the present embodiment.

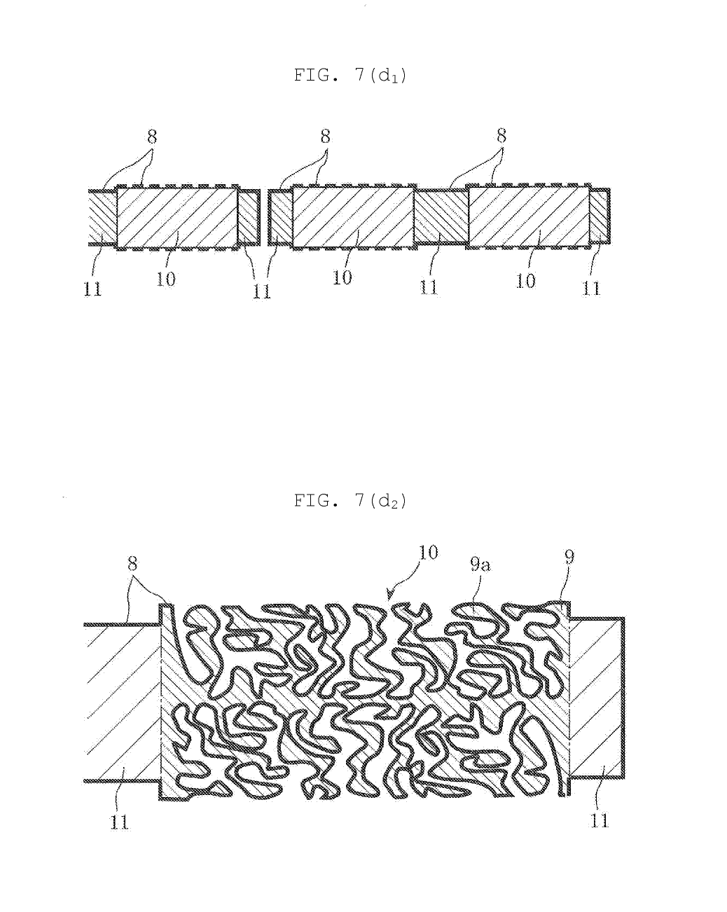

Next, as shown in FIG. 7(d₁), the dielectric layer 8 is formed on the surface of the aggregate substrate 9. FIG. 7(d₂) is an enlarged sectional view of a main part of FIG. 7(d₁). The dielectric layer 8 is specifically formed in a prescribed region of the surface of the aggregate substrate 9 including the inner surfaces of the pores 9a, as shown in FIG. 7(d₂).

A method of forming the dielectric layer 8 is not particularly limited, and the dielectric layer 8 can also be manufactured by a chemical vapor deposition (hereinafter, referred to as “CVD”) method, a physical vapor deposition (hereinafter, referred to as “PVD”) method or the like; however, the dielectric layer 8 is preferably formed by an atomic layer deposition (hereinafter, referred to as “ALD”) method from the viewpoint of obtaining a dielectric layer 8 which is thin and dense and has a low leakage current and high insulating properties.

That is, in the CVD method, it is difficult to form a dielectric layer 8 having a uniform film thickness up to a deep inner surface of the fine pores 9a of the order of a nano since an organic metal compound as a precursor and a reaction gas such as water are simultaneously supplied to a reaction chamber and reacted to form a film. Further, the same is true on the PVD method in which a solid material is used.

In contrast, in the ALD method, an organic metal precursor is supplied to a reaction chamber to be chemically adsorbed, then the organic metal precursor excessively existing in a vapor phase is purged and removed, and then the adsorbed organic metal precursor is reacted with a reaction gas such as water vapor in the reaction chamber, and thereby, a thin film can be deposited in increments of an atomic layer in a prescribed region of the surface of the aggregate substrate 9 including the inner surfaces of the pores 9a. Accordingly, by repeating the above-mentioned process, thin films are laminated in increments of an atomic layer, and consequently a dense dielectric layer 8 of high quality having a uniform prescribed film thickness can be formed up to a deep inner surface of the pores 9a.

As described above, when the dielectric layer 8 is produced by the ALD method, it is possible to obtain a dielectric layer 8 which is thin and dense and has a low leakage current and high insulating properties, and to obtain a high capacity capacitor which has a stable capacity and good reliability.

Next, as shown in FIG. 8(e), for the second region site 11 at which the terminal electrode should be formed, a flange-like mask part 12 is formed on the aggregate substrate 9 so as to cover the second region site 11.

In addition, a material and a method for forming the mask part 12 are not particularly limited, and for example, as a forming material, an epoxy resin, a polyimide resin, a silicone resin, a fluororesin or the like can be used, and as a forming method, an optional method, such as a printing method, a dispenser method, a dip method, an ink-jet method, a spraying method and a photolithography method, can be used.

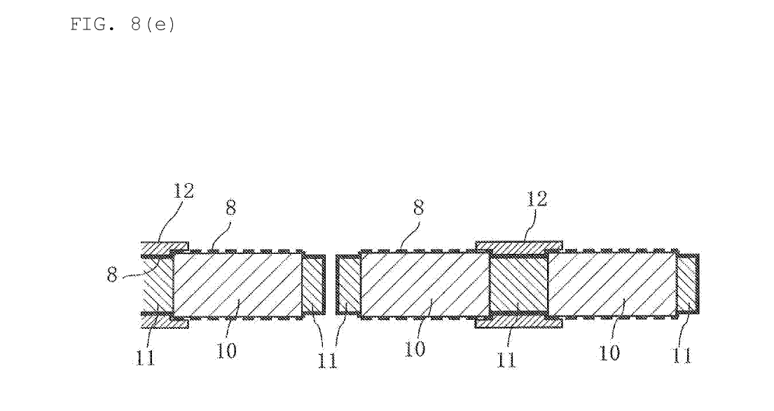

Next, as shown in FIG. 9(f₁), the conductive part 5 is formed on the surface of the dielectric layer 8. FIG. 9(f₂) is an enlarged sectional view of a main part of FIG. 9(f₁). The conductive part 5 is specifically filled in the inside of the pores 9a on which a dielectric layer 8 is formed and formed in a prescribed region of the surface of the aggregate substrate 9 including the inner surfaces of the pores 9a, as shown in FIG. 9(f₂).

A method of forming the conductive part 5 is also not particularly limited, and for example, a CVD method, a plating method, a bias sputtering method, a sol-gel method, a conductive polymer filling method or the like can be used; however, in order to attain a conductive part 5 which is dense and highly precise, an ALD method which is excellent in film-forming properties is preferably used as with the dielectric layer 8. Further, for example, a conductive layer is produced, by the ALD method, on the surface of the dielectric layer 8 formed inside the pores 9a, and an electrical conductive material may be filled in the pores 9a having the conductive layer produced thereon by a CVD method, a plating method or the like to thereby form a conductive part 5.

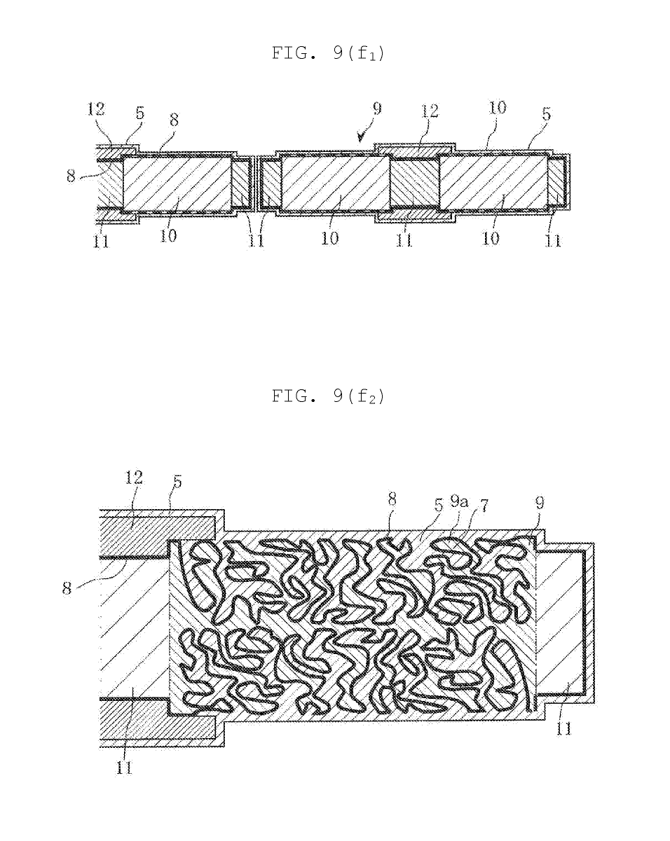

Next, using the same cutting method as in FIGS. 6(a) to 6(c) described above, the aggregate substrate 9 is cut along a broken line E to separate the aggregate substrate 9 into segments as element main body units as shown in FIG. 10(g), and thereby, an element main body 2 including the high specific surface area substrate 7 is obtained. That is, the element main body 2 has, at a central portion, the first region 3 with a large void ratio which principally contributes to the acquisition of the capacitance, and the second regions 4a and 4b are formed so as to continue across the first region 3. Further, the high specific surface area substrate 7 is exposed to the surface at the end surface of the second region 4a, and the conductive part 5 is exposed to the surface at the end surface of the second region 4b.

Next, the element main body 2 is subjected to a washing treatment or a heat treatment to remove the mask part 12, as shown in FIG. 10(h).

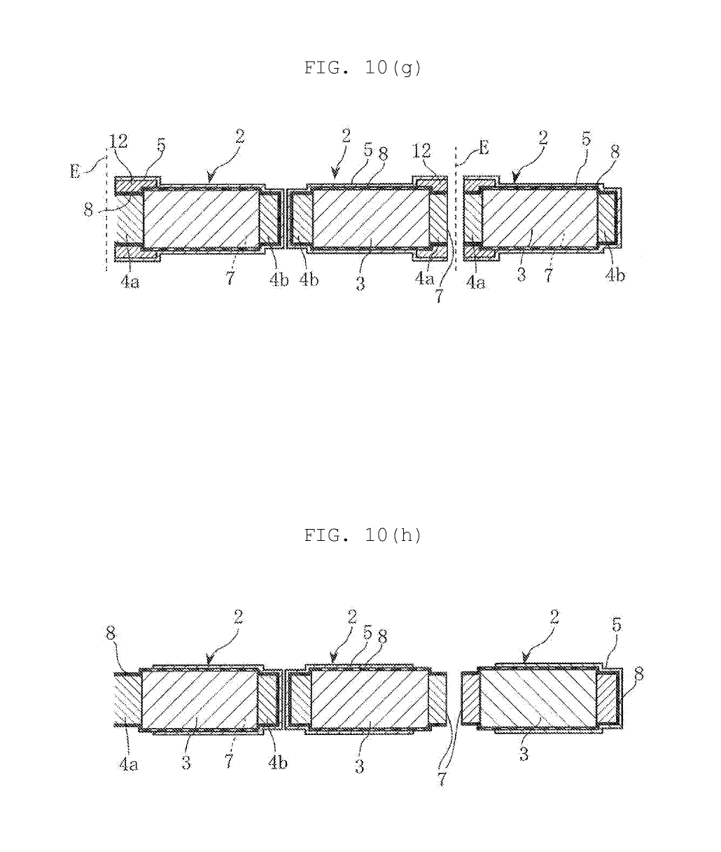

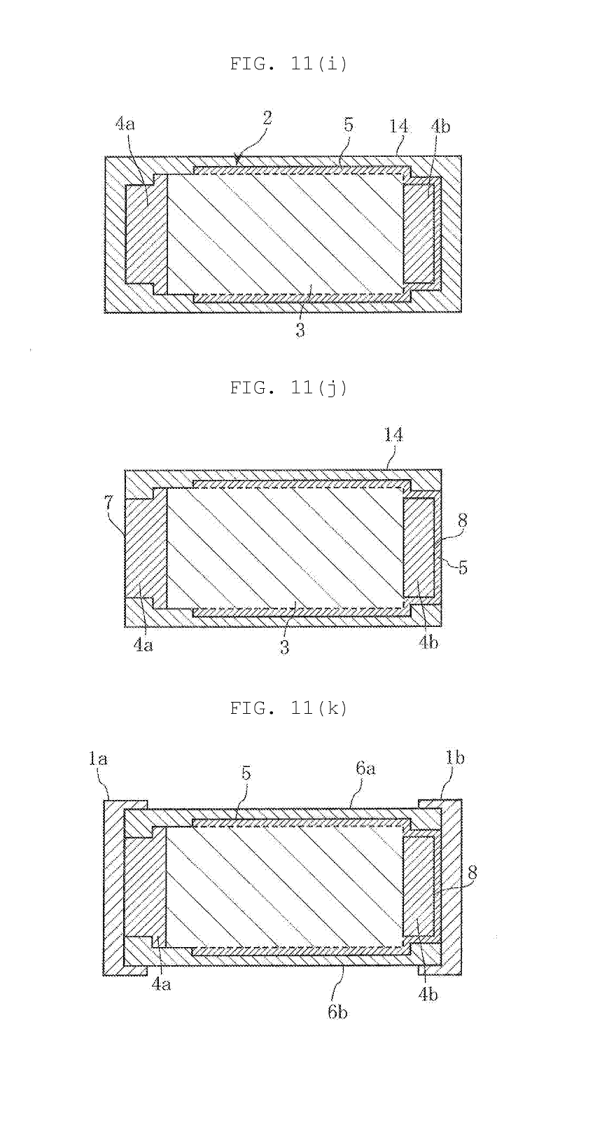

Next, as shown in FIG. 11(i), the element main body 2 is covered with an insulating material 14 using an appropriate method such as a CVD method, a plating method, a sputtering method, a spraying method or a printing method.

Next, as shown in FIG. 11(j), an insulating material 14 at both end surfaces of the insulating material 14 is eliminated by etching, protective layers 6a and 6b are formed as shown in FIG. 11(k), and thereby, the high specific surface area substrate 7 is exposed to the surface from one second region 4a, and the conductive part 5 is exposed to the surface from the other second region 4b.

Finally, a plating treatment or application/baking of a conductive paste is performed to form a first terminal electrode 1a and a second terminal electrode 1b at both ends of the element main body 2.

In addition, in the present embodiment, the element main body 2 is covered with an insulating material 14, and then etching is applied to sites at which the first and the second terminal electrodes 1a and 1b are formed, but patterning is performed with the insulating material 14 by a dispenser method or the like so as to expose, to the surface, the sites at which the first and the second terminal electrodes 1a and 1b are formed to form protective layers 6a and 6b, and thereafter, the first terminal electrode 1a and the second terminal electrode 1b may be formed.

As described above, according to the above manufacturing method, a capacitor can be obtained with high efficiency from a large aggregate substrate 9 by a so-called multi-piece method, the capacitor being small and high capacity, having high insulating properties, and having high quality and high reliability to suppress the occurrence of deformation or the like in a production process. That is, since the second region site 11 has good mechanical strength, it is possible to inhibit the aggregate substrate 9 from deforming or the element main body 2 obtained by separating the aggregate substrate 9 into segments from deforming during a manufacturing process.

In the present capacitor, since the mechanical strength is secured by the second region site 11 having a void ratio as small as 25% or less, it is possible to inhibit the occurrence of delamination, cracks, and short circuit resulting from deformation of the element main body 2.

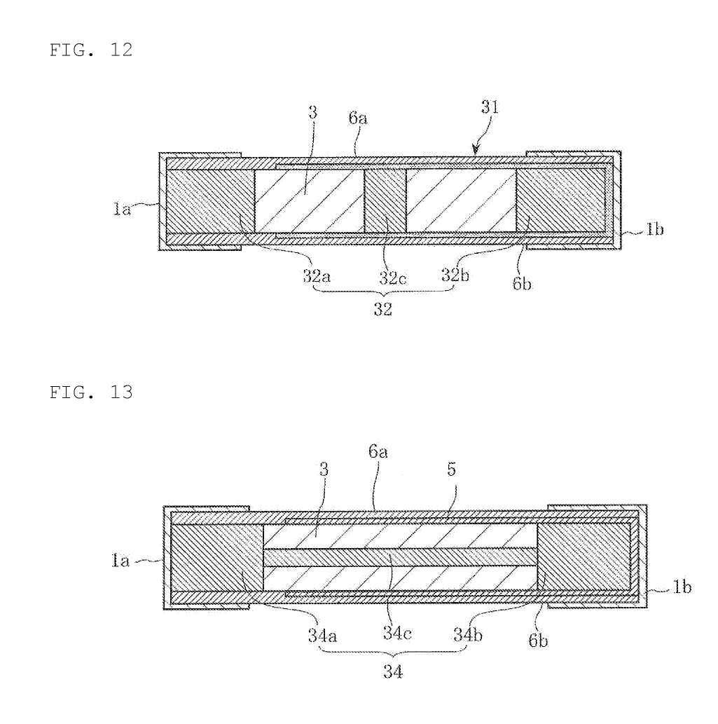

FIG. 12 is a schematic cross-sectional view of a second embodiment of a capacitor according to the present invention.

In the first embodiment, two second regions 4a and 4b are provided consecutively at both ends of the first region 3, respectively, but in the second embodiment, a second region 32 has a third site 32c, in addition to a first site 32a and a second site 32b, which is interposed in the first region 3 in parallel to an end surface of an element main body 31. That is, in the present second embodiment, the second region 32 is formed of the first site 32a to the third site 32c, and thereby, the mechanical strength is further enhanced.

In addition, the second embodiment can be easily produced by appropriately pressing an aggregate substrate or irradiating an aggregate substrate with laser so as to obtain required number of the second region sites in the aggregate substrate by the same method/procedure as in the first embodiment.

FIG. 13 is a schematic cross-sectional view of a third embodiment of a capacitor according to the present invention.

In the third embodiment, a second region 34 has a first and a second sites 34a and 34b provided consecutively at both ends of the first region 3, respectively, and a third site 34c interposed in the first region 3, and the first site 34a is connected to the second site 34b with the third site 34c interposed therebetween.

As described above, since the second region 34 has the third site 34c, in addition to the first and the second sites 34a and 34b, which is connected between the first site 34a and the second site 34b, the mechanical strength can be further enhanced, and production of a defective product, such as the deformation of the element main body in a production process, can be effectively suppressed.

In addition, the capacitor of the present third embodiment can be easily manufactured in the following manner. That is, for example, etching is applied to the aggregate substrate 9 from an upper surface side and a lower surface side, and etching is terminated at a stage where etching proceeds up to the vicinity of a central portion to leave a metal portion, and thereby, the third site 34c can be produced. Further, since the first and the second sites 34a and 34b can be produced by the same method/procedure as in the first embodiment described above, the second region 34 can be easily produced.

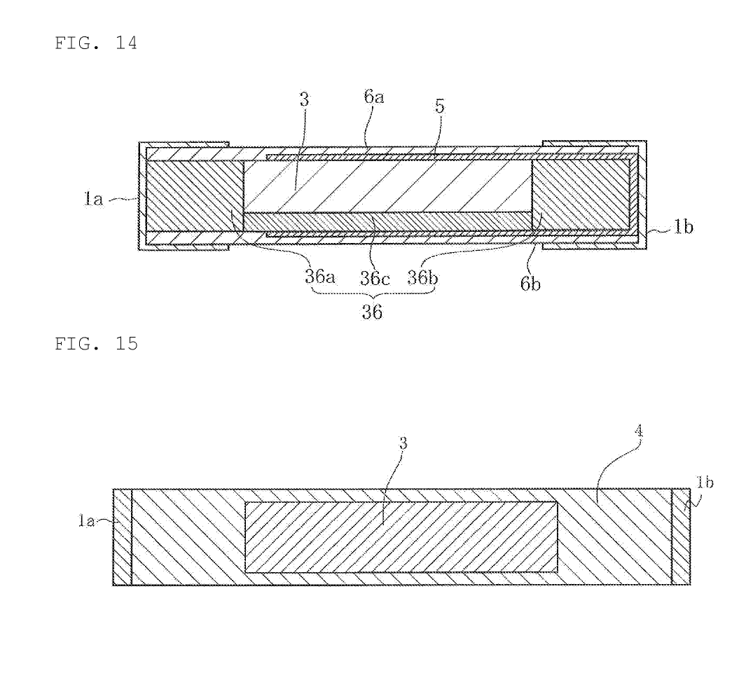

FIG. 14 is a schematic cross-sectional view of a fourth embodiment of a capacitor according to the present invention.

In the fourth embodiment, a second region 36 has a first and a second sites 36a and 36b provided consecutively at both ends of the first region 3, respectively, and a third site 36c formed along a lower surface of the first region 3, and the first site 36a is connected to the second site 36b with the third site 36c interposed therebetween.

As described above, since the second region 36 has the third site 36c which is connected between the first site 36a and the second site 36b, nearly the same as in the third embodiment, the mechanical strength can be further enhanced, and production of a defective product, such as the deformation of the element main body in a production process, can be effectively suppressed.

In addition, the capacitor of the present fourth embodiment can also be easily produced in the following manner.

That is, for example, etching is applied to the aggregate substrate 9 from an upper surface side, and etching is terminated at a stage where etching proceeds up to the vicinity of a lower surface to leave a metal portion, and thereby, the third site 36c can be produced. Further, since the first and the second sites 36a and 36b can be produced by the same method/procedure as in the first embodiment described above, the second region 36 can be easily produced.

FIG. 15 is a schematic cross-sectional view of a fifth embodiment of a capacitor according to the present invention, and shows another embodiment of the sectional view viewed from the arrow direction of the X-X line of FIG. 1.

That is, in the first embodiment, the second regions 4a and 4b respectively having as small a void ratio as 25% or less are provided consecutively at both ends of the first region 3 having a high void ratio, but the second region 4 may be formed so as surround the first region 3 like the present fifth embodiment.

In the fifth embodiment, the capacitance slightly tends to decrease since the first region 3 is narrowed, but from the viewpoint of placing emphasis on the securement of the mechanical strength, it is preferred to form a capacitor so that the first region 3 is surrounded with the second region 4 like the fifth embodiment.

As described above, in the present invention, it is preferred to appropriately change a regional ratio and a shape of the first and the second regions or the like according to uses or required performance/quality, and thereby, it becomes possible to attain a capacitor which is small, high capacity, and highly reliable, and has high mechanical strength without impairing insulating properties or the like.

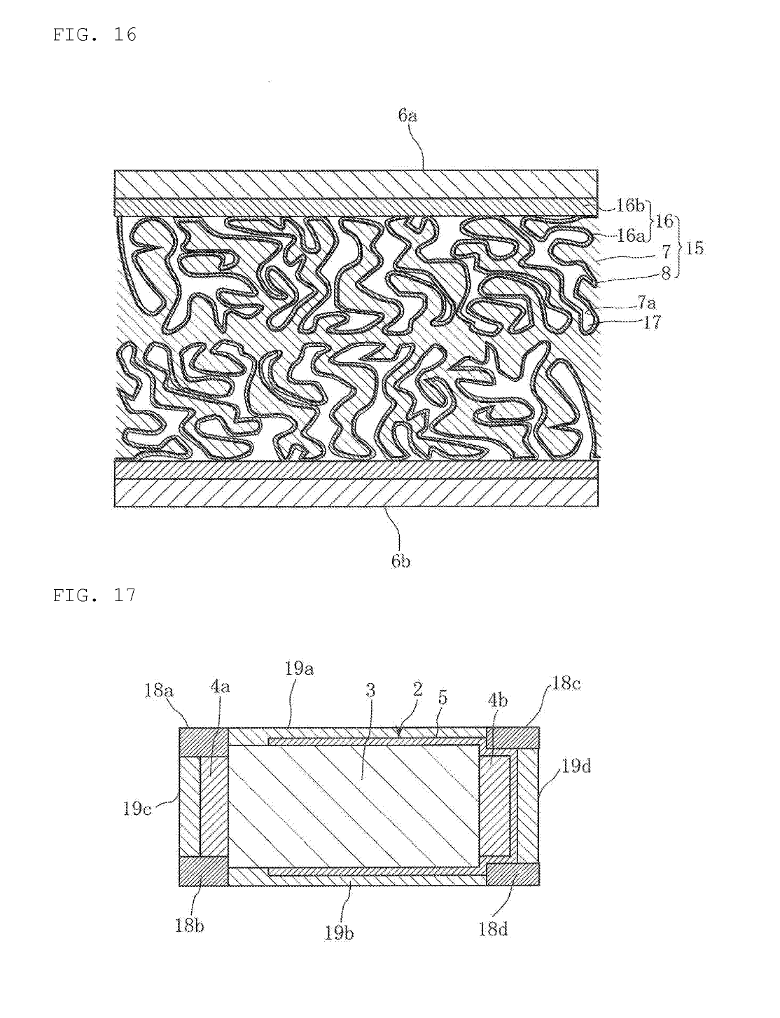

FIG. 16 is a schematic enlarged sectional view of a main part of a sixth embodiment of a capacitor according to the present invention, and shows a detail of a first region 15.

Also in the present sixth embodiment, as with the first embodiment, the first region 15 has a high specific surface area substrate 7 made of an electrical conductive material which has a large number of fine pores 7a formed therein, a dielectric layer 8 which is formed in a prescribed region of the surface including the inner surfaces of the pores 7a, and a conductive part 16.

Then, while in the first embodiment, the conductive part 5 is filled in the pores 7a, in the present sixth embodiment, a conductive part 16 has a main conductive part 16a which is formed in a prescribed region of the surface in a state of meeting the dielectric layer 8 so that a cavity 17 is formed at an inner surface of the pore 7a, and a sub conductive part 16b which is electrically connected to the main conductive part 16a and extended in a side surface direction.

As described above, the main conductive part 16a may be formed so that the cavity 17 is formed inside the pore 7a. In doing so, the main conductive part 16a is preferably formed by the ALD method which is suitable for forming a thin layer in the pores 7a as with the first embodiment, and the sub-conductive part 16b can be formed by the plating method or the sputtering method, for example. Then, in doing so, with respect to the material for forming the conductive part 16, the main conductive part 16a preferably uses a metal nitride such as TiN or a metal oxynitride, or a metal material such as Ru, Ni, Cu or Pt which is suitable for the ALD method, and the sub-conductive part 16b preferably uses a metal material, such as Cu or Ni, in which lower resistance can be achieved and ESR can be reduced.

In addition, a part of or all the cavity 17 may be filled with a resin or a glass material, for example, after forming the main conductive part 16a.

The sixth embodiment can also be produced by the same method/procedure as in the first embodiment, and for example, a main conductive part 16a is produced, and then in the subsequent step, a sub-conductive part 16b can be produced. A metal film such as Cu can be formed on the sub-conductive part 16b as required to further reduce resistance.

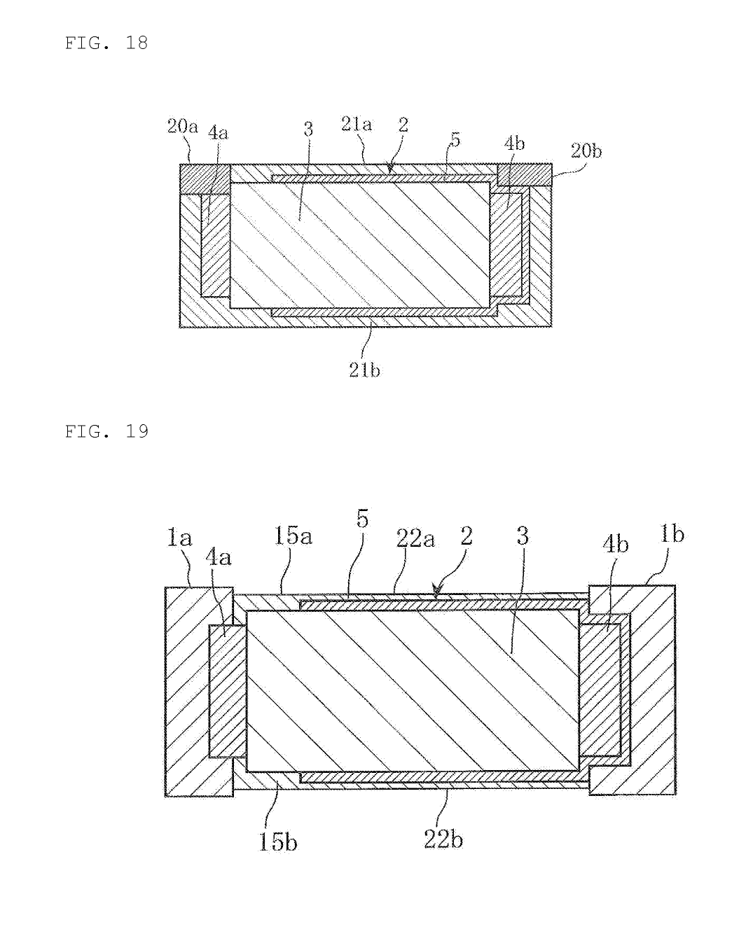

FIG. 17 is a schematic cross-sectional view of a seventh embodiment of a capacitor according to the present invention, and in the present seventh embodiment, the first and the second terminal electrodes 18a to 18d are formed at four corner parts of the element main body 2.

That is, in the element main body 2, protective layers 19a and 19b are formed on the side surfaces of the first region 3, and protective layers 19c and 19d are formed on the end surfaces of the second regions 4a and 4b, respectively. Further, the dielectric layer is not formed on one second region 4a, and is formed on only the first region 3 that principally contributes to the acquisition of the capacitance and the other second region 4b. Then, the first terminal electrodes 18a and 18b are formed on an upper surface and a lower surface of the second region 4a of the element main body 2 and on an upper surface and a lower surface of the protective layer 19c, and these first terminal electrodes 18a and 18b are electrically connected to the high specific surface area substrate. Further, the second terminal electrodes 18c and 18d are formed on an upper surface and a lower surface of the second region 4b of the element main body 2 and on an upper surface and a lower surface of the protective layer 19d, and these second terminal electrodes 18c and 18d are electrically connected to the conductive part 5, and electrically insulated from the high specific surface area substrate with the dielectric layer interposed therebetween.

As described above, the first and the second terminal electrodes 18a to 18d may each have a plurality of electrodes, and may be formed not on the end surface of the element main body 2 but on the surface of a corner part.

In the seventh embodiment, distances between the first and the second terminal electrodes 18a to 18d and the conductive part 5 can be shortened, and thereby, resistance can be further reduced and ESR can be further reduced.

The capacitor of the seventh embodiment can be easily manufactured in the following manner.

That is, many element main bodies 2 are acquired from a large aggregate substrate by nearly the same method/procedure as in the first embodiment described above. However, in this case, the dielectric layer is formed on only the first region 3 and the second region 4b of the high specific surface area substrate, and is not formed on the second region 4a. Then, for the element main body 2 thus formed, protective layers 19a to 19d are provided.

Here, the protective layers 19a to 19d can be produced by covering the entire element main body 2 with an insulating material to serve as a protective layer, removing a corner part by etching or masking a corner part with a masking material, covering a location exposed to the surface with an insulating material, and then eliminating the masking material.

Then, thereafter, the first and the second terminal electrodes 18a to 18d are produced using a plating method, an application/firing method or the like, and thereby, a capacitor of the present seventh embodiment can be obtained.

In addition, in the seventh embodiment, while the first region 3 meets the first terminal electrodes 18a and 18b, the first terminal electrodes 18a and 18b have only to meet the second region 4a, and may be formed so as not to meet the first region 3.

FIG. 18 is a schematic cross-sectional view of an eighth embodiment of a capacitor according to the present invention, and in the present eighth embodiment, the first and the second terminal electrodes 20a and 20b are formed at two corner parts of the element main body 2.

That is, the element main body 2 is covered with protective layers 21a and 21b excluding locations on which the first and the second terminal electrodes 20a and 20b are formed. Further, as with the third embodiment, the dielectric layer is not formed on one second region 4a, and is formed on only the first region 3 that contributes to the acquisition of the capacitance and the other second region 4b. Then, the first terminal electrode 20a is formed at the second region 4a of the element main body 2 and on an upper surface of one side of the protective layer 21b, and the first terminal electrode 20a is electrically connected to the high specific surface area substrate. Further, the second terminal electrode 20b is formed at the second region 4b of the element main body 2 and on an upper surface of the other side of the protective layer 21b, and the second terminal electrode 20b is electrically connected to the conductive part 5, and electrically insulated from the high specific surface area substrate with the dielectric layer interposed therebetween.

In the eighth embodiment, as with the seventh embodiment, distances between the first and the second terminal electrodes 20a and 20b and the conductive part 5 can be shortened, and thereby, resistance can be further reduced and ESR can be further reduced.

In the present eighth embodiment, since the first and the second terminal electrodes 20a and 20b are formed on and at the second regions 4a and 4b, mechanical strength of a periphery of the first and the second terminal electrodes 20a and 20b on which the stresses tend to concentrate is improved, and therefore the mechanical strength of an entire capacitor can be enhanced.

The capacitor of the eighth embodiment can be easily manufactured by nearly the same method as in the seventh embodiment.

That is, many element main bodies 2 are acquired from a large aggregate substrate by nearly the same method/procedure as in the seventh embodiment described above, and protective layers 21a and 21b are formed on each of the element main bodies 2.

Here, the protective layers 21a and 21b can be produced by nearly the same method as in the seventh embodiment. That is, the protective layers 21a and 21b can be produced by covering the entire element main body 2 with an insulating material to serve as a protective layer, removing an upper corner part by etching or masking an upper corner part with a masking material, covering a location exposed to the surface with an insulating material, and then eliminating the masking material.

Then, thereafter, the first and the second terminal electrodes 20a and 20b are produced using a plating method, an application/firing method or the like, and thereby, a capacitor of the present eighth embodiment can be obtained.

In addition, in the eighth embodiment, while the first region 3 meets the first terminal electrode 20a, as with the seventh embodiment, the first terminal electrode 20a has only to meet the second region 4a, and may be formed so as not to meet the first region 3.

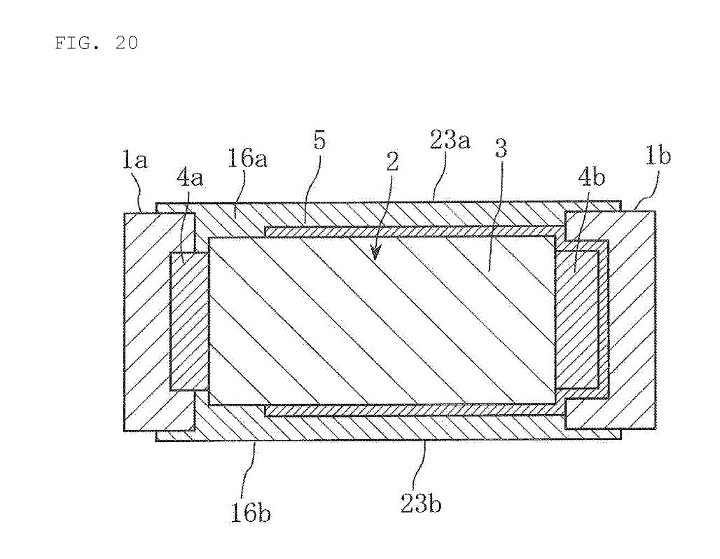

FIG. 19 is a schematic cross-sectional view of a ninth embodiment of a capacitor according to the present invention, and FIG. 20 is a schematic cross-sectional view of a tenth embodiment of a capacitor according to the present invention.

In the ninth embodiment, as shown in FIG. 19, protective layers 22a and 22b are formed in the form of a thin film. By making the protective layers 22a and 22b thin in this way so that these layers are lower than an overall height of the first and the second terminal electrodes 1a and 1b, it is possible to inhibit the inclination of a component at the time of being placed still which can occur due to the projections and depressions of the protective layers 22a and 22b.

Further, in the tenth embodiment, as shown in FIG. 20, protective layers 23a and 23b are formed in the form of a thick film. By making the protective layers 23a and 23b thick in this way so that these layers are higher than an overall height of the first and the second terminal electrodes 1a and 1b, it is possible to inhibit the migration resulting from a metal material constituting the first and the second terminal electrodes 1a and 1b.

As described above, in the present invention, it is also preferred to appropriately change a shape or the like according to uses or required performance/quality, and thereby, it becomes possible to attain a capacitor which is small and high capacity and has a wide application range.

In addition, the present invention is not limited to the above-mentioned embodiments, and various variations may be further made.

For example, the dielectric layer 8 may be formed in a prescribed region of the surface including the pores 7a of the high specific surface area substrate 7, and an intermediate layer may be interposed between the dielectric layer 8 and the high specific surface area substrate 7 in order to improve adhesion.

Further, a manufacturing procedure described above is an example, and it is not limited to the above embodiment and various variations, for example, may be made as long as the capacitor of the present invention is obtained. For example, in the above embodiments, the comparting treatment to compart the aggregate substrate 9 into the first region site 10 and the second region site 11 is performed before the formation of the dielectric layer 8, but the comparting treatment may be performed after the formation of the dielectric layer 8. Further, for example, in the above embodiments, the mask part 12 is formed before the formation of the dielectric layer 8, but the dielectric layer 8 may be formed before the formation of the mask part 12.

Next, examples of the present invention will be specifically described.

### EXAMPLE

### Production of Specimen

As an aggregate substrate, an etched Al foil of 50 mm long, 50 mm wide and 110 μm thick was prepared.

Then, preparing a die having a width of 200 μm, press working was applied to the Al foil at intervals of 1.0 mm long and 0.5 mm wide to cause the destruction of pores, and thereby, the Al foil was comparted into a first region site and a second region site. In addition, in this comparting treatment, the Al foil was cut for every prescribed width of the element main body.

Then, the Al foil was cut by laser irradiation so as to form a set of two first region sites between which the second region site is sandwiched (refer to FIGS. 6(a) to 6(c)).

Next, a dielectric layer made of Al₂O₃ was formed in a prescribed region of the surface including inner surfaces of pores of the Al foil by using an ALD method for the Al foil. Specifically, trimethyl aluminum (Al(CH₃)₃) (hereinafter, referred to as “TMA”) gas was used as an organic metal precursor, TMA was supplied to a reaction chamber in which the Al foil was placed still to adsorb the TMA on the Al foil, the TMA gas excessively existing in a vapor phase was purged, and then ozone (O₃) was supplied to the reaction chamber to react the TMA with O₃ to form a thin film made of Al₂O₃. This process was repeated plural times so as to have a film thickness of 20 nm to form a dielectric layer made of Al₂O₃ in a prescribed region of the surface including inner surfaces of pores of the Al foil (refer to FIGS. 7(d₁) to 7(d₂)).

Next, screen printing was performed using a polyimide resin to form a mask part on a location on which the first terminal electrode is to be formed (refer to FIG. 8(e)).

Then, a conductive part made of TiN was produced on the dielectric layer. Specifically, titanium tetrachloride (TiCl₄) gas was used as an organic metal precursor, titanium tetrachloride was supplied onto the Al foil having a dielectric layer formed thereon to adsorb the titanium tetrachloride on the dielectric layer, the TiCl₄ gas excessively existing in a vapor phase was purged, and then an ammonia (NH₃) gas was supplied to the reaction chamber to react the TiCl₄ gas with the NH₃ gas to form a thin film made of TiN. Then, this process was repeated plural times so as to have a film thickness of 10 nm to form a conductive part made of TiN on the dielectric layer (refer to FIGS. 9(f₁) to 9(f₂)).

Thereafter, this was immersed in an electroless Cu-plating bath to form a Cu film having a thickness of 10 on the conductive part.

Next, a roughly central part of the mask part was cut by laser irradiation, and then the mask part was removed by heat treatment at a temperature of 400° C. to 500° C. to thereby obtain an element main body (refer to FIGS. 10(g) to 10(h)). In addition, the element main body is comparted into a first region and a second region by the above-mentioned comparting treatment.

Next, using a CVD method, the element main body was covered with an insulating material made of SiO₂ so as to have a thickness of about 1 μm. Then, both end surfaces of the element main body were etched using a fluorine gas to remove the insulating material on the both end surfaces of the element main body, and thereby, protective layers were formed.

Then, using a plating method, a Ni layer having a thickness of 5 μm and a Sn layer having a thickness of 3 μm were formed in turn at both ends of the element main body, and thereby, a first terminal electrode and a second terminal electrode were produced to obtain samples of sample numbers 1 to 6 from one sheet of Al foil (refer to FIGS. 11(i) to 11(k)).

### Evaluation of Specimen

### Void Ratio

Two samples were optionally extracted from each of the samples of sample numbers 1 to 6, and the void ratios of the first region and the second region of each of the two samples were measured by the following method.

First, using an FIB (focused ion beam) apparatus (manufactured by Seiko Instrument Inc., SMI 3050SE), roughly central parts of the first region and the second region of each sample was processed by a FIB pick-up method to be made a thin piece so that a thickness is about 50 nm, and thereby, a measuring samples were produced. In addition, a FIB-damaged layer produced in making the etching foil a thin piece was removed using an Ar ion milling apparatus (manufactured by GATAN, Inc., PIPS model 691).

Next, using a scanning transmission electron microscope (JEM-2200FS manufactured by JEOL Ltd.), a region of 3 μm long and 3 μm wide was selected as an imaging region, and five optional locations were imaged. Then, the resulting images were analyzed, an area of an Al existing region (hereinafter, referred to as “existing area”) al was determined, and a void ratio x of each of the first region and the second region was calculated based on a formula (1) from the existing area a1 and a measurement area a2 (=3 μm×3 μm).

x={(a2−a1)/a2}×100 (1)

Then, an average value of void ratios x of five locations of each region was determined. The average value of void ratios x of each region which is calculated on each sample, that is, an average void ratio is taken as the void ratio of each sample.

### Defective Rate

200 samples optionally extracted from samples of each of sample numbers 1 to 6 were observed with an optical microscope, the presence or absence of an abnormal state such as deformation was checked, and a sample causing the abnormal state was counted as a defective article to determine a defective rate.

### Capacitance

20 non-defective samples excluding defective articles were optionally extracted from 200 samples of each of sample numbers 1 to 6. Then, using an impedance analyzer (manufactured by Agilent Technologies, Inc., E4990A), capacitances of these 20 samples of each of sample numbers 1 to 6 were measured under the conditions of a voltage of 1 Vrms and a measuring frequency of 1 kHz at a temperature of 25° C.±2° C.

### Dielectric Breakdown Voltage

With respect to the above-mentioned 20 samples of each of sample numbers 1 to 6, a DC voltage applied between terminals of the capacitor was gradually increased, and a voltage at the time when a current passing through the sample exceeded 1 mA, that is, a dielectric breakdown voltage, was measured.

Table 1 shows the void ratio, the defective rate, the capacitance (average value), and the dielectric breakdown voltage (average value) of the samples of each of sample numbers 1 to 6.

TABLE 1

| | | | | | Dielectric |
|---|---|---|---|---|---|
| | Void Ratio (%) | | Defective | | Breakdown |
| Sample | First | Second | Rate | Capacitance | Voltage |
| No. | region | region | (%) | (μF) | (V) |
| 1 | 57 | 3 | 1 | 0.42 | 14.6 |
| 2 | 57 | 9 | 3 | 0.42 | 14.4 |
| 3 | 57 | 18 | 5 | 0.43 | 14.4 |
| 4 | 57 | 25 | 8 | 0.44 | 14.2 |
| 5* | 57 | 42 | 28 | — | — |
| 6* | 57 | 57 | 100 | — | — |

A symbol * represents “out of the scope of the present invention.

In the sample No. 6, the void ratio of the second region was the same as that of the first region, a region having a small void ratio was not substantially provided, the defective rate was 100%, and all articles were defective.

In the sample No. 5, it was found that the void ratio of the second region was 42% and smaller than the void ratio of the first region, but it was not small enough to secure mechanical strength, and therefore the defective rate was as large as 28%, the product yield was low, and sufficient reliability cannot be attained.

In contrast, in each of the sample numbers 1 to 4, it was found that since the void ratio of the second region was 3 to 25% and within the scope of the present invention, the defective rate was 8% or less, the product yield can be markedly improved, and high reliability can be attained.

Further, in the sample numbers 1 to 4, it was found that the capacitance was 0.42 to 0.44 μF, the dielectric breakdown voltage was 14.2 to 14.6 V, and therefore a capacitor having high insulating properties and a high capacity can be obtained.

The present invention achieves a new type of capacitor which is small, high capacity, and highly reliable, and has high mechanical strength without impairing insulating properties.

### DESCRIPTION OF REFERENCE SYMBOLS

1a, 18a, 18b, 20a: First terminal electrode (one terminal electrode)

1b, 18c, 18d, 20b: Second terminal electrode (the other terminal electrode)

2: Element main body

3: First region

4, 4a, 4b, 32, 34, 36: Second region

5: Conductive part

6a, 6b, 19a-19d, 21a, 21b, 22a, 23b: Protective layer

7a: Pore

7: High specific surface area substrate

8: Dielectric layer

9: Aggregate substrate

9a: Pore

10: First region site (first region)

11: Second region site (second region)

1. A capacitor comprising:
an element main body made of an electrical conductive material, the element main body having a first region with a plurality of pores therein and has a first void ratio, the first region principally contributing to the acquisition of a capacitance, and a second region having a second void ratio smaller than the first void ratio of the first region, the second void ratio being 25% or less;
a dielectric layer in a prescribed region of a surface of the element main body including inner surfaces of the plurality of pores;
a conductive part on the dielectric layer;
a first terminal electrode electrically connected to the element main body; and
a second terminal electrode electrically connected to the conductive part and electrically insulated from the first terminal electrode.

2. The capacitor according to claim 1, wherein the first void ratio of the first region is 30 to 80%.

3. The capacitor according to claim 1, wherein the first void ratio of the first region is 35 to 65%.

4. The capacitor according to claim 1, wherein the element main body includes two second regions provided at respective opposed ends of the first region.

5. The capacitor according to claim 4, further comprising a third second region interposed in the first region between the two second regions and in parallel to an end surface of the element main body.

6. The capacitor according to claim 4, further comprising a third second region interposed in the first region, and the third second region is connected to each of the two second regions.

7. The capacitor according to claim 6, wherein the third second region extends along at least one principal surface of the first region.

8. The capacitor according to claim 1, wherein the second region surrounds the first region.

9. The capacitor according to claim 1, wherein the dielectric layer is interposed between the conductive part and the element main body, and the element main body and the second terminal electrode are electrically insulated from each other.

10. The capacitor according to claim 1, wherein the dielectric layer is formed by being deposited in increments of an atomic layer.

11. The capacitor according to claim 1, wherein the conductive part extends into the plurality of pores.

12. The capacitor according to claim 1, wherein the conductive part extends along the dielectric layer inside the pores.

13. The capacitor according to claim 1, wherein the electrical conductive material is a metal material.

14. The capacitor according to claim 1, wherein the conductive part is any one of a metal material and a conductive compound.

15. The capacitor according to claim 14, wherein the conductive compound contains a metal nitride or a metal oxynitride.

16. The capacitor according to claim 1, further comprising a protective layer made of an insulating material covering at least side surface parts of the element main body.

17. The capacitor according to claim 16, further comprising a metal film interposed between the protective layer and the conductive part.
